(19) United States
(12) Patent Application Publication
(10) Pub. No.: US 2024/0079836 A1
(43) Pub. Date: Mar. 7, 2024

(54) EXTENSION CORD SOCKET

(71) Applicant: MAX STAR ELECTRIC CO., LTD., Taichung City (TW)

(72) Inventor: Shou-Shih YUNG, Taichung City (TW)

(21) Appl. No.: 17/939,386

(22) Filed: Sep. 7, 2022

(51) Int. Cl. H01R 35/02

(52) U.S. Cl. CPC H01R 35/025

(57) ABSTRACT

An extension cord socket is provided, including a main body and a rotating assembly. The main body includes a first housing and a second housing connected with each other, and the first housing has at least one electrical outlet disposed thereon. The rotating assembly is rotatably disposed between the first housing and the second housing. Relative to a rotary axis of the rotating assembly, the rotating assembly has a first opening radially open outwardly, and the rotating assembly and the main body define a second opening therebetween. The second opening is open radially toward an interior of the main body.

### BACKGROUND OF THE INVENTION

### Field of the Invention

The present invention relates to an extension cord socket.

### Description of the Prior Art

Generally, an extension cord is connected to a wall socket to increase a number of electrical outlets and a distance between a socket of the extension cord and the wall socket for ease of use. A conventional extension cord includes a socket seat and a cord fixedly connected to the socket seat, and an end of the cord connected to the socket seat is immovable relative to the socket seat. A connection between the socket seat and the cord is easy to be deformed or damaged in long-term use, which affects the use efficiency and increases the risk. Therefore, an extension cord with a cord being adjustable relative to the socket seat is developed.

However, the conventional extension cord has a complicated structure, which is inconvenient to assemble and high cost; and a rotational mechanism between the socket seat and the cord cannot provide sufficient bending allowance, which may also be deformed or damaged in long-term use and have safety concern.

The present invention is, therefore, arisen to obviate or at least mitigate the above-mentioned disadvantages.

### SUMMARY OF THE INVENTION

The main object of the present invention is to provide an extension cord socket, which has a simple structure and is easy to process and manufacture.

To achieve the above and other objects, the present invention provides an extension cord socket, including: a main body and a rotating assembly. The main body includes a first housing and a second housing connected with each other, and the first housing has at least one electrical outlet disposed thereon. The rotating assembly is rotatably disposed between the first housing and the second housing. Relative to a rotary axis of the rotating assembly, the rotating assembly has a first opening radially open outwardly, and the rotating assembly and the main body define a second opening therebetween. The second opening is open radially toward an interior of the main body.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a partial breakdown drawing of a preferable embodiment of the present invention;

FIG. 3 is another partial breakdown drawing of a preferable embodiment of the present invention;

FIG. 4 is an enlargement of a first housing and a rotating assembly according to a preferable embodiment of the present invention;

FIG. 5 is a partial breakdown drawing of a preferable embodiment of the present invention as viewed from another side;

FIG. 6 is an enlargement of FIG. 5;

FIG. 7 is a partial cross-sectional view of FIG. 1; and

FIGS. 8-9 are schematic diagrams showing operation of a preferable embodiment of the present invention.

### DETAILED DESCRIPTION OF THE PREFERRED EMBODIMENTS

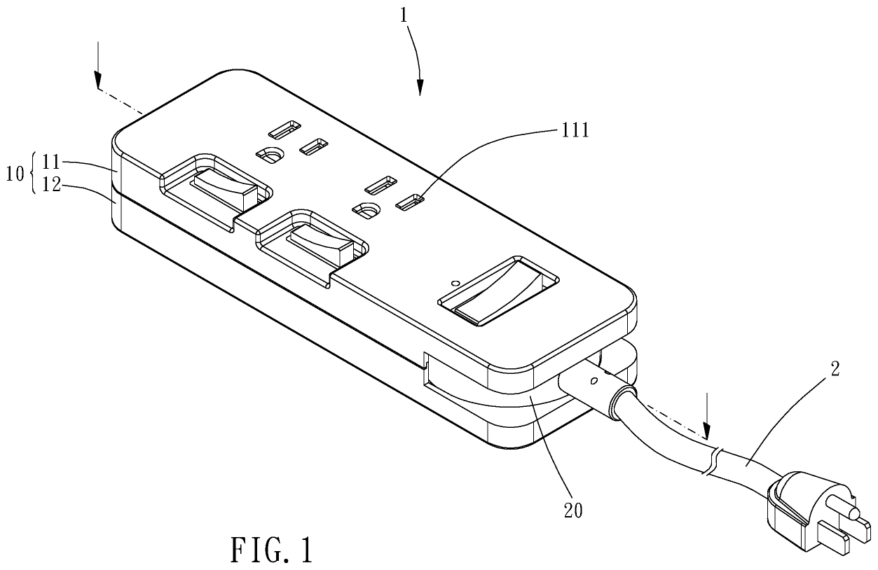

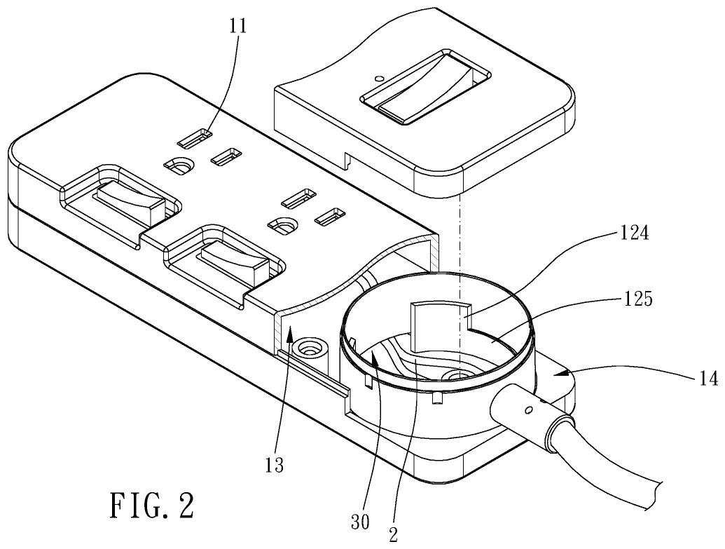

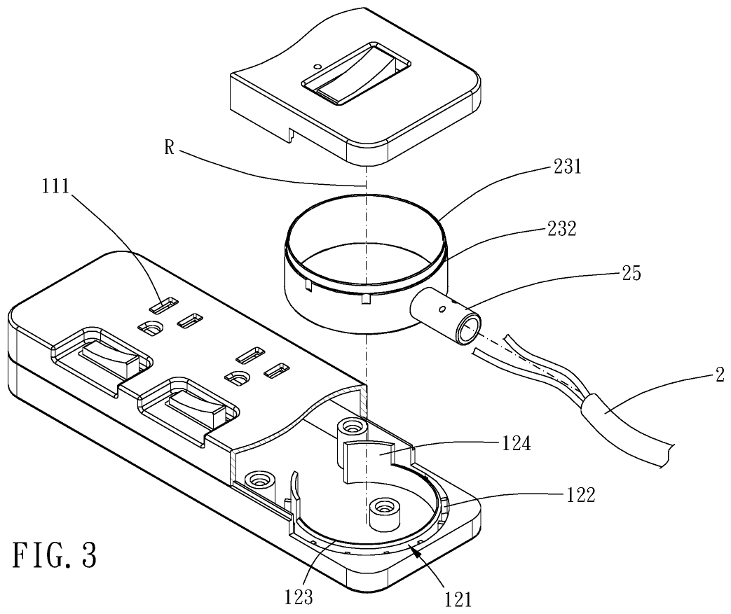

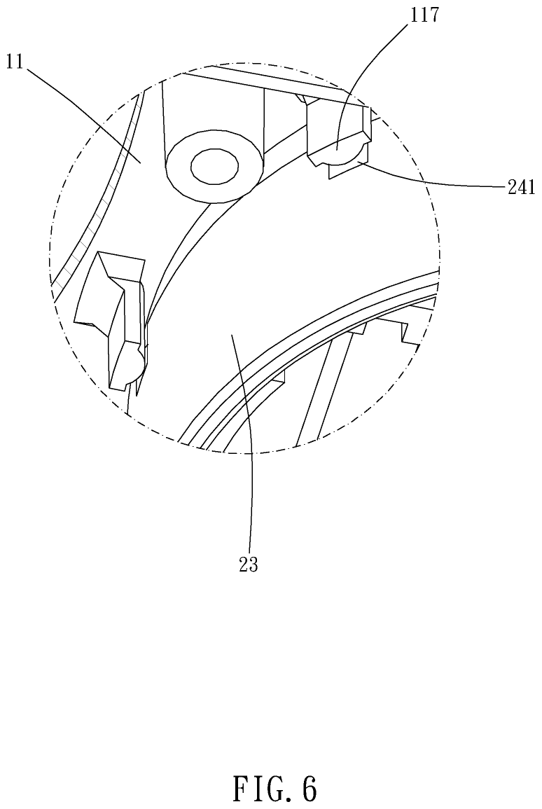

Please refer to FIGS. 1 to 9 for a preferable embodiment of the present invention. An extension cord socket 1 of the present invention includes a main body 10 and a rotating assembly 20.

The main body 10 includes a first housing 11 and a second housing 12 connected with each other, and the first housing 11 has at least one electrical outlet 111 disposed thereon. The rotating assembly 20 is rotatably disposed between the first housing 11 and the second housing 12. Relative to a rotary axis R of the rotating assembly 20, the rotating assembly 20 has a first opening 21 radially open outwardly, the rotating assembly 20 and the main body 10 define a second opening 30 therebetween, and the second opening 30 is open radially toward an interior of the main body 10. Therefore, the extension cord socket 1 has a simple structure and is easy to process and manufacture.

One of the main body 10 and the rotating assembly 20 includes at least one guiding groove, and the other of the main body 10 and the rotating assembly 20 includes at least one guiding projection 22 movably disposed within the at least one guiding groove. A bottom groove wall of the at least one guiding groove has a plurality of ribs 122, and the at least one guiding projection 22 is axially abutted against the plurality of ribs 122. Therefore, the rotating assembly 20 and the main body 10 are partially spaced apart from each other to define the second opening 30 therebetween, which also reduces friction therebetween for smooth rotation. Preferably, the at least one guiding groove includes a first guiding groove 112 disposed on the first housing 11 and a second guiding groove 121 disposed on the second housing 12, and the rotating assembly 20 includes two said guiding projections 22 respectively corresponding to the first guiding groove 112 and the second guiding groove 121. The first guiding groove 112 and the second guiding groove 121 respectively extend around the rotary axis R and are radially open to a side of the main body 10 adjacent to the at least one electrical outlet 111 so as to have good guiding effect, be convenient to manufacture and assemble, and be easy to arrange wires 2.

Specifically, the first housing 11 includes a first convex portion 113, and the second housing 12 includes a second convex portion 123. The first convex portion 113 and the second convex portion 123 are respectively arranged annularly around the rotary axis R and at least partially abutted circumferentially against the rotating assembly 20 for stable assembling. One of the first convex portion 113 and the second convex portion 123 is radially open in a direction toward the at least one electrical outlet 111 and defines the second opening 30 with the rotating assembly 20, and the second opening 30 is configured for the wires 2 to penetrate therethrough. In this embodiment, the first convex portion 113 and an inner circumferential wall of the first housing 11 define the first guiding groove 112 therebetween, and the second convex portion 123 and an inner circumferential wall of the second housing 12 define the second guiding groove 121 therebetween. The first convex portion 113 is a ring wall enclosed circumferentially and extending continuously, the second convex portion 123 is a annular wall radially open toward the at least one electrical outlet 111, and the annular wall and the rotating assembly 20 define the second opening 30 therebetween. The plurality of ribs 122 are disposed in the second guiding groove 121 and integrally connected with the annular wall. With the structure as described above, a side of the rotating assembly 20 adjacent to the at least one electrical outlet 111 is spaced apart from the second housing 12 and defines the second opening 30 with the annular wall. When the rotating assembly 20 is rotated relative to the main body 10, a position of the second opening 30 relative to the main body 10 is unchanged, which prevents the wires 2 from over-bending, tugging and damage and is durable to use. Preferably, the first convex portion 113 is integrally formed as a part of the first housing 11, and the second convex portion 123 is integrally formed as a part of the second housing 12 so as to have good structural strength and is easy to manufacture. In other embodiments, the first guiding groove may also have the plurality of ribs, and the first annular wall may be radially open in a direction toward the at least one electrical outlet and define another said second opening with the rotating assembly, which also reduces friction therebetween and allows the wires to penetrate therethrough to meet various requirements; the first convex portion and the second convex portion may respectively include a plurality of pieces spaced apart from one another.

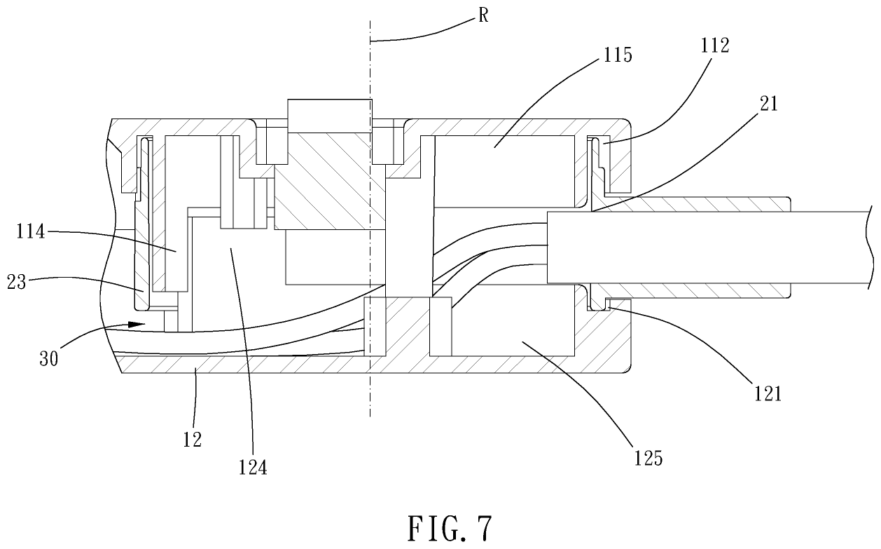

In this embodiment, the rotating assembly 20 includes an annular member 23 enclosed circumferentially, and a circumferential wall of the annular member 23 extends in a direction parallel to the rotary axis R and includes two annular edges 231 abutted respectively against the first housing 11 and the second housing 12. The two annular edges 231 are respectively embedded within the first guiding groove 112 and the second guiding groove 121 for stable guiding and connection. One of the first convex portion 113 and the second convex portion 123 includes a first extending segment 114 close to the at least one electrical outlet 111, and the other of the first convex portion 113 and the second convex portion 123 includes two second extending segments 124 located at two opposite sides of the first extending segment 114. In this embodiment, the first convex portion 113 and the second convex portion 123 further respectively includes a guiding segment 115, 125, and the first extending segment 114 and the two second extending segments 124 are connected with respective one of said guiding segments 115, 125. As viewed in a direction lateral to the rotary axis R, each of the said guiding segments 115, 125 is dislocated with the first opening 21, and the first extending segment 114 and the two second extending segments 124 at least partially correspond to the first opening 21, as shown in FIG. 7. When the rotating assembly 20 is rotated relative to the main body 10, the wires 2 are movable between the said guiding segments 115, 125 of the first convex portion 113 and the second convex portion 123 without interference, which provides smooth operation. In assembling, the first extending segment 114 is directly inserted between the two second extending segments 124, which is convenient to position and assemble and can stably and radially block the annular member 23.

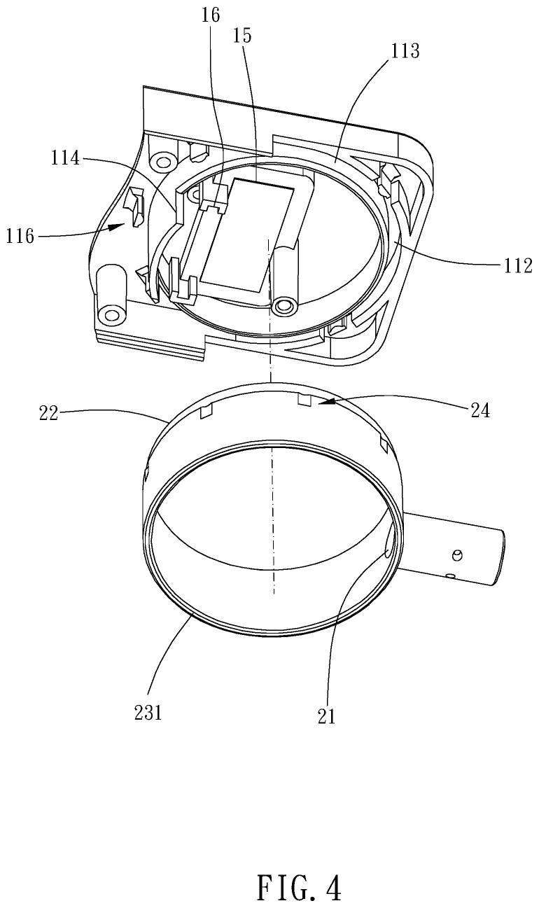

Please refer to FIGS. 4 to 6, at least one of the first housing 11 and the second housing 12 includes a first positioning portion 116, and the rotating assembly 20 includes a second positioning portion 24 releasably engaged with the first positioning portion 116. When the first positioning portion 116 is engaged with the second positioning portion 24, the rotating assembly 20 is non-rotatable relative to the main body 10 so as to avoid unexpectedly rotation of the rotating assembly 20 and protect the wires 2 and other components from being damaged. One of the first positioning portion 116 and the second positioning portion 24 includes at least one engaging projection 117, and the other of the first positioning portion 116 and the second positioning portion 24 includes at least one engaging recession 241 engaged with the at least one engaging projection 117. In this embodiment, the first positioning portion 116 includes a plurality of said engaging projections 117 spacedly arranged around the first guiding groove 112, and the second positioning portion 24 includes a plurality of said engaging recessions 241 corresponding to the plurality of engaging projections 117 for stable engagement. The annular member 23 further includes an annular stepped portion 232 adjacent to one of the two annular edges 231, and the second positioning portion 24 is disposed on a side of a circumferential wall of the annular member 23 adjacent to the annular stepped portion 232, which is easy to process and manufacture. In other embodiments, the first positioning portion may have only one said engaging projection; the first positioning portion may be disposed on the first convex portion or the second convex portion, and the second positioning portion may be disposed on an inner surface of the annular member.

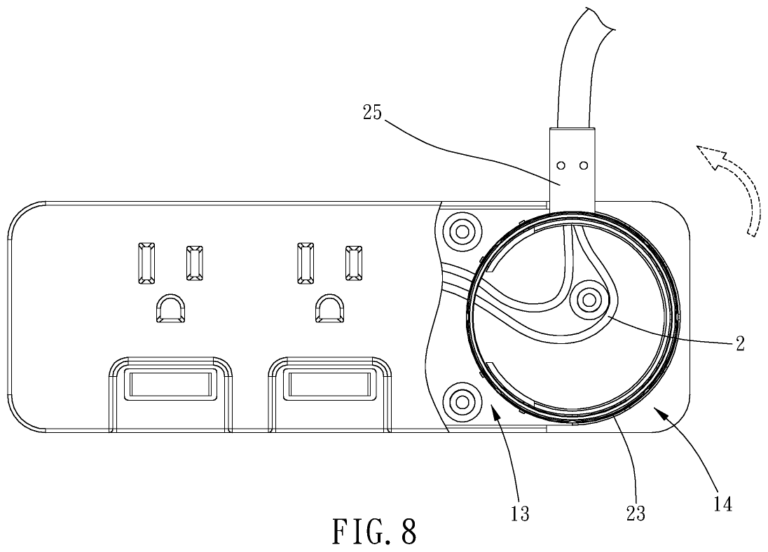

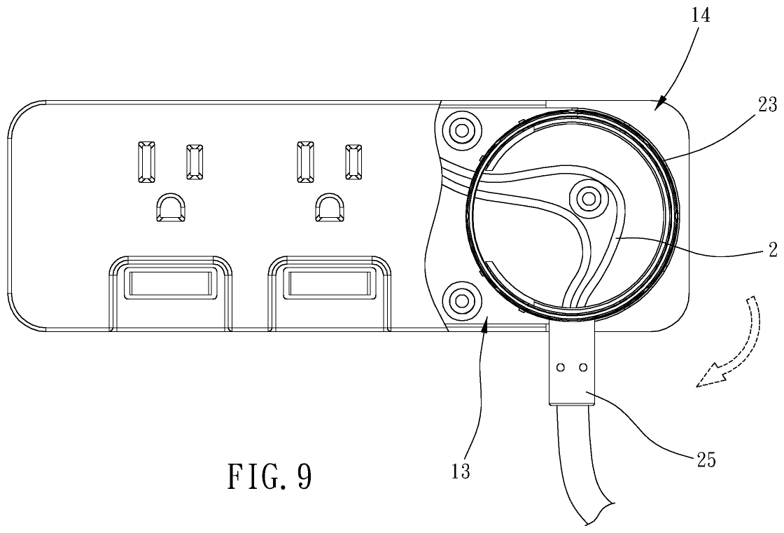

Please refer to FIGS. 8 and 9, the first housing 11 and the second housing 12 define an inner space 13 therebetween. The main body 10 further includes a notch 14 disposed between the first housing 11 and the second housing 12, and the notch 14 is communicated with the inner space 13. The rotating assembly 20 further includes a sleeving portion 25 radially protruding from the annular member 23, and the sleeving portion 25 corresponds to the first opening 21. The sleeving portion 25 is configured to be sleeved on the wires 2 so that the sleeving portion 25 and the wires 2 are co-movable within the notch 14, and the sleeving portion 25 is abuttable against the main body 10 to avoid over-rotation. In a longitudinal direction lateral to the rotary axis R, at least ½ of the annular member 23 is located within the notch 14, and at least ¼ of the annular member 23 is located within the inner space 13. Therefore, the rotating assembly 20 is rotatable relative to the main body 10 with a maximum angle, meanwhile, the second opening 30 is not exposed from the notch 14 to avoid objects from entering the inner space 13 or exposure of the wires 2.

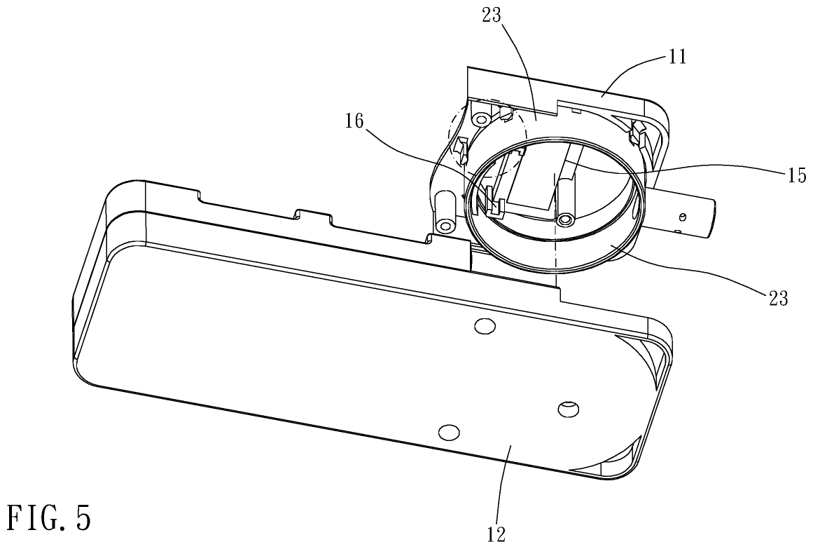

Preferably, the main body 10 further includes a switch assembling hole 15 and at least one receiving groove 16 adjacent to the switch assembling hole 15, and the switch assembling hole 15 and the at least one receiving groove 16 are located within the annular member 23 (as shown in FIG. 5). The switch assembling hole 15 is configured for a safety switch to be assembled therewithin, and the at least one receiving groove 16 is configured for a circuit device, electrically connected with the wires 2 and the safety switch, to be disposed therewithin so as to achieve automatic power-off or power management effects, increase safety of use and facilitate the miniaturization of the extension cord socket 1.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A extension cord socket, including:
a main body, including a first housing and a second housing connected with each other, the first housing having at least one electrical outlet disposed thereon; and
a rotating assembly, rotatably disposed between the first housing and the second housing, relative to a rotary axis of the rotating assembly, the rotating assembly having a first opening radially open outwardly, the rotating assembly and the main body defining a second opening therebetween, the second opening being open radially toward an interior of the main body.

2. The extension cord socket of claim 1, wherein at least one of the first housing and the second housing includes a first positioning portion, the rotating assembly includes a second positioning portion being releasably engaged with the first positioning portion; and when the first positioning portion is engaged with the second positioning portion, the rotating assembly is non-rotatable relative to the main body.

3. The extension cord socket of claim 1, wherein the rotating assembly includes an annular member enclosed circumferentially, and a circumferential wall of the annular member extends in a direction parallel to the rotary axis and includes two annular edges abutted respectively against the first housing and the second housing.

4. The extension cord socket of claim 1, wherein one of the main body and the rotating assembly includes at least one guiding groove, the other of the main body and the rotating assembly includes at least one guiding projection movably disposed within the at least one guiding groove, a bottom groove wall of the at least one guiding groove has a plurality of ribs spacedly disposed thereon, and the at least one guiding projection is axially abutted against the plurality of ribs.

5. The extension cord socket of claim 4, wherein the at least one guiding groove includes a first guiding groove disposed on the first housing and a second guiding groove disposed on the second housing, and the first guiding groove and the second guiding groove respectively extend around the rotary axis and are radially open to a side of the main body adjacent to the at least one electrical outlet.

6. The extension cord socket of claim 1, wherein the first housing includes a first convex portion, the second housing includes a second convex portion, and the first convex portion and the second convex portion are respectively arranged annularly around the rotary axis and at least partially abutted circumferentially against the rotating assembly.

7. The extension cord socket of claim 6, wherein one of the first convex portion and the second convex portion is radially open in a direction toward the at least one electrical outlet and defines the second opening with the rotating assembly.

8. The extension cord socket of claim 6, wherein one of the first convex portion and the second convex portion includes a first extending segment close to the at least one electrical outlet, and the other of the first convex portion and the second convex portion includes two second extending segments located at two opposite sides of the first extending segment.

9. The extension cord socket of claim 8, wherein the first convex portion and the second convex portion further respectively includes a guiding segment, the first extending segment and the two second extending segments are connected with respective one of said guiding segments, as viewed in a direction lateral to the rotary axis, each of the said guiding segments is dislocated with the first opening, and the first extending segment and the two second extending segments at least partially correspond to the first opening.

10. The extension cord socket of claim 5, wherein at least one of the first housing and the second housing includes a first positioning portion, the rotating assembly includes a second positioning portion releasably engaged with the first positioning portion; and when the first positioning portion is engaged with the second positioning portion, the rotating assembly is non-rotatable relative to the main body; one of the first positioning portion and the second positioning portion includes at least one engaging projection, the other of the first positioning portion and the second positioning portion includes at least one engaging recession engaged with the at least one engaging projection; the rotating assembly includes an annular member enclosed circumferentially, and a circumferential wall of the annular member extends in a direction parallel to the rotary axis and includes two annular edges abutted respectively against the first housing and the second housing; the annular member further includes a annular stepped portion adjacent to one of the two annular edges, and the second positioning portion is disposed on a side of a circumferential wall of the annular member adjacent to the annular stepped portion; the rotating assembly further includes a sleeving portion radially protruding from the annular member, and the sleeving portion corresponds to the first opening; the first housing includes a first convex portion, the second housing includes a second convex portion, and the first convex portion and the second convex portion are respectively arranged annularly around the rotary axis and at least partially abutted circumferentially against the rotating assembly; the first convex portion and an inner circumferential wall of the first housing define the first guiding groove therebetween, and the second convex portion and an inner circumferential wall of the second housing define the second guiding groove therebetween; the first convex portion is a ring wall enclosed circumferentially and extending continuously, the second convex portion is a annular wall radially open toward the at least one electrical outlet, the annular wall and the rotating assembly define the second opening therebetween; the plurality of ribs are disposed in the second guiding groove and integrally connected with the annular wall; the first convex portion includes a first extending segment close to the at least one electrical outlet, the second convex portion includes two second extending segments located at two opposite sides of the first extending segment; the first convex portion and the second convex portion further respectively includes a guiding segment, the first extending segment and the two second extending segments are connected with respective one of said guiding segments, as viewed in a direction lateral to the rotary axis, each of the said guiding segments is dislocated with the first opening, and the first extending segment and the two second extending segments at least partially correspond to the first opening; the first convex portion is integrally formed as a part of the first housing, and the second convex portion is integrally formed as a part of the second housing; the first housing and the second housing define an inner space therebetween, the main body further includes a notch disposed between the first housing and the second housing, the notch is communicated with the inner space; in a longitudinal direction lateral to the rotary axis, at least ½ of the annular member is located within the notch, and at least ¼ of the annular member is located within the inner space; and the main body further includes a switch assembling hole and at least one receiving groove adjacent to the switch assembling hole, and the switch assembling hole and the at least one receiving groove are located within the annular member.
